(19) United States
(12) Patent Application Publication
(10) Pub. No.: US 2012/0035982 A1
(43) Pub. Date: Feb. 9, 2012

(54) System For Providing Retail Store Information

(75) Inventors: Rajesh Narayan, Atlanta, GA (US); Hernan Mujica, Norcross, GA (US); Rajesh S. Varikat, Kennesaw, GA (US)

(73) Assignee: Home Depot USA, Inc., Atlanta, GA (US)

(21) Appl. No.: 12/852,109

(22) Filed: Aug. 6, 2010

(51) Int. Cl. G06Q 10/00; G06F 15/16; G06F 3/048

(52) U.S. Cl. 705/7.31; 715/810; 709/219

(57) ABSTRACT

A system for providing retail store information is described. Specifically, the system enables store inventory and sales data to be delivered to a mobile device in retail stores. The system may comprise a data warehouse, a data access object, a web service, a data transmission server, and a mobile device. The data warehouse may store and process store inventory and sales data. The data access object may provide an interface to the data warehouse. The web service may format data for transmission to an internet network. The data transmission server may transmit data to the mobile device. The mobile device may display requested store inventory and sales data.

### FIELD OF THE INVENTION

The present invention generally relates to a system for providing retail store information. More particularly, sales data and forecasts, and inventory data and forecasts may be processed by a data warehouse and communicated to a mobile device.

### BACKGROUND OF THE INVENTION

Retail stores offer goods directly to consumers for purchase. Some stores offer a wide range of goods, while others offer highly specialized and limited products. Although consumers are increasingly purchasing retail goods online through the internet, retailers still generate significant sales through traditional storefronts.

Retailers typically maintain records of product sales. Sales data may be collected at point of sale devices. The data may subsequently be processed to calculate revenue.

### SUMMARY OF THE INVENTION

A method is provided for making sales history and forecast available on a mobile device. The method may comprise: displaying a plurality of icons on a mobile device, wherein at least one of the plurality of icons provides retail store information if selected; receiving input from a user to display retail store information; displaying sales history of a retail store on the device; and displaying sales forecast of the retail store on the device.

A system is provided for communicating sales and inventory information to retail store associates. The system comprises a data warehouse, a data access object, a data transmission server, and a mobile device. The data warehouse may store retail store data. The data access object may be coupled to the data warehouse to access data stored in the data warehouse. The data transmission server may be coupled to the data access object to transmit the data to a wireless network. The mobile device may be coupled to the data transmission server to display the data to a user, wherein the data comprises sales history, sales forecast, inventory and inventory forecast.

A mobile device is provided to provide a means for accepting input from a user, a means for requesting retail store information from a data warehouse, a means for receiving retail store information from the data warehouse, a means for displaying existing sales data, and a means for displaying forecasted sales data.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE DRAWINGS

FIG. 1 is a block diagram of a system for providing retail store information.

FIG. 2 is a flowchart for writing information to memory.

FIG. 3 is a flowchart for displaying retail information to a mobile device.

FIG. 4 is a mobile device interface having at least a first icon for a user to retrieve sales data or inventory data.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components, and circuits have not been described in detail so as not to obscure the present invention.

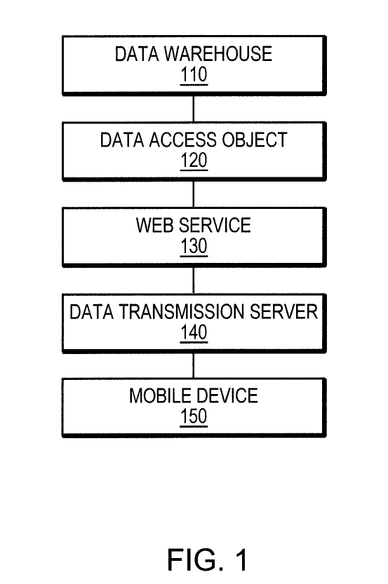

FIG. 1 depicts an embodiment of a system for providing retail store information. The system comprises data warehouse 110, data access object 120, web service 130, data transmission server 140, and mobile device 150. Data warehouse 110 is coupled to data access object 120. Data access object 120 is coupled to web service 130. Web service 130 is coupled to data transmission server 140. Data transmission server 140 is coupled to mobile device 150.

Data warehouse 110 may be a repository for retail data. The retail data may include sales and inventory information for one or more stores. The data warehouse 110 may be a Teradata® Active Enterprise Data Warehouse 5600.

Mobile device 150 may submit requests to data warehouse 110 to access stored retail data. Mobile device 150 may transmit the request using a wireless signal. For one embodiment of the invention, the wireless signal may be communicated via an internet network. A Uniform Resource Locator (URL) may be provided by the mobile device 150 to specify the location of the stored retail data and the retrieval mechanism. The mobile device 150 may be a Motorola®MC75 Worldwide Enterprise Digital Assistant.

Data transmission server 140 may provide a platform for communicating data with applications of mobile device 150. The data communicated between data transmission server 140 and mobile device 150 may be in Extensible Markup Language (XML) format. Because the data transmitted from data transmission server 140 to mobile device 150 is typically larger than the data requests from mobile device 150 to data transmission server 140, the transmission server 140 may compress and encrypt data to be communicated to mobile device 150. The mobile device 150 may comprise software to decompress and decrypt the data received from transmission server 140. The data transmission server 140 may be an Antenna Vaultus™ mobiScaler Framework.

Web service 130 may be invoked by data transmission server 140. Web service 130 may provide an interface between data transmission server 140 and data access object 120. Data access object 120 controls operations, such as extract, transform, and load functions, on data warehouse 110. The functions may be defined by data warehouse 110. Data stored in data warehouse 110 may be in American Standard Code for Information Interchange (ASCII) format. Similarly, data access object 120 may process data communicated between data warehouse 110 and web service 130 in ASCII format. Web service may convert data between XML and ASCII formats.

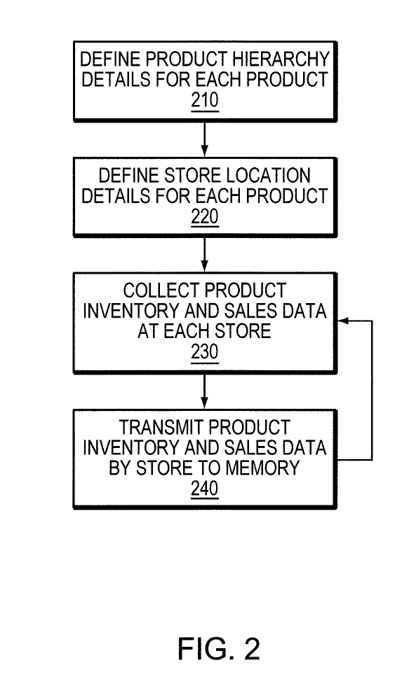

FIG. 2 shows a flowchart for writing information to data warehouse 110, or to other memory. In operation 210, product information is defined. Each product may be assigned a department, class, subclass, and store-keeping unit (SKU). The department may define a collection of similar products. For example, departments in a home improvement store may comprise hardware, lighting, flooring, garden, paint, plumbing, and electrical departments. The departments may further be comprised of a plurality of classes. For example, flooring may have interior and exterior classes. Classes may further be comprised of a plurality of subclasses. For example, the interior flooring class may comprise carpet, hardwood, laminate, and stone subclasses. Each product may also be assigned a unique SKU.

In operation 220, store information is defined. Aisles for each retail store may be defined. The aisles may further be divided into bays or racks. To help organize store layout, like products may be placed in the same aisle or bay number.

In operation 230, product inventory and sales data are collected at each store. Inventory data may be collected using a scanner that is part of a mobile device. For example, when products are delivered to retail stores, the SKU on each product may be scanned to confirm the number of products delivered. Each SKU may be assigned a corresponding aisle and bay number at each store. Sales data may be collected by point of sale devices, such as store cash registers. The point of sale device may track the current inventory of each SKU that is available for retail sale.

In operation 240, the collected inventory and sales data in operation 230 may be stored to a memory. The data may be communicated from a scanner or a point of sale device to a memory via a wireless signal. For one embodiment of the invention, the collected inventory and sales data may be stored to a database. For another embodiment of the invention, the collected inventory and sales data may be stored to a data warehouse 110.

Operation 230 and operation 240 may be periodically repeated to update the inventory and sales data stored to memory. For example, these operations may be repeated once a day.

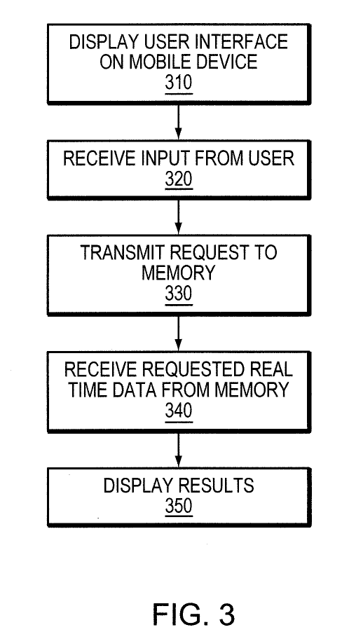

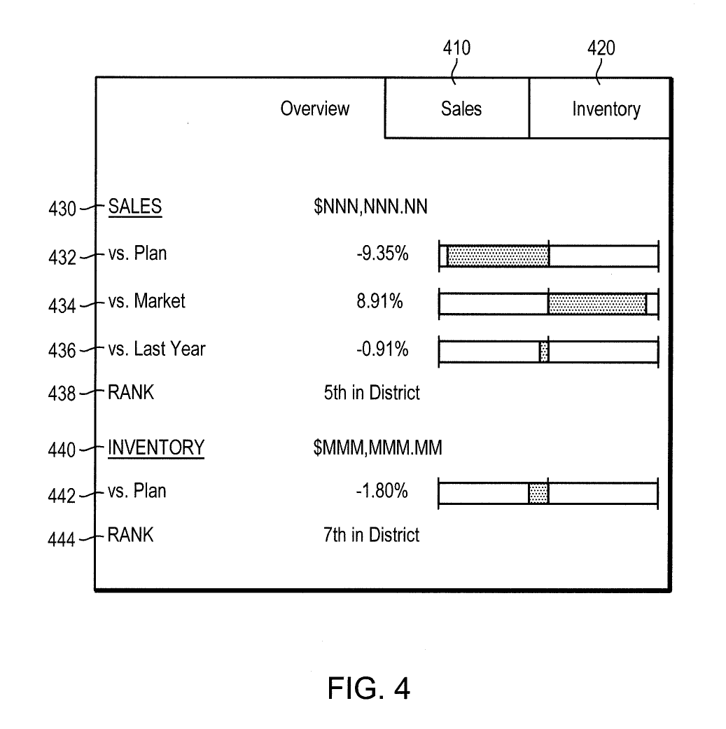

FIG. 3 shows a flowchart for displaying retail information to a mobile device 150. In operation 310, a graphical user interface is displayed on the mobile device 150. FIG. 4 shows one embodiment of the graphical user interface.

The interface may provide an overview of a store's current sales data. For example, the interface may display the net sales amount 430, the net sales amount versus company plans 432, the net sales amount versus competitors in the market 434, the net sales amount versus last year 436, and the rank of the store's net sales compared to other stores in the district 438.

The interface may also provide an overview of a store's inventory data. For example, the interface may display the total inventory value 440, the inventory value versus company plans 442, and the rank of the store's inventory value compared to other stores in the district 444.

Additionally, the mobile device interface may have a first icon 410 to provide sales details, and a second icon 420 to provide inventory details. The sales details may comprise sales history of all stores, a plurality of selected stores, or a single store. The inventory details may comprise the number of products available across all stores, a plurality of selected stores, or a single store.

The first icon 410 and the second icon 420 may be selected by a user using an electronic pointer. For example, to select the first icon 410, the user may electrically couple the electronic pointer to the first icon 410. In operation 320, the user request may be received by the mobile device 150.

Once the first icon 410 or the second icon 420 is selected, additional icons may be displayed to allow the user to refine the search. Additional icons may allow the user to select specific stores of interest, and to select the format of the retrieved data. Options may include showing inventory or sales data by quantity, by change in quantity from a previous date or time period, or by quantity forecast. Icons may also allow the user to sort the retrieved data by store, department, class, subclass, or SKU. If the user requests retrieval of inventory or sales data for a single store, icons may allow the user to sort the retrieved data by aisle or bay.

In operation 330, each user request may be transmitted from mobile device 150 to data warehouse 110. The transmission may be made via a wireless signal.

The data warehouse 110 may then process the user request. For example, if the user request is to display the sales forecast of a SKU in a store, a central processing unit of data warehouse 110 may extract the SKU's sales data over a predefined period of time, extract the SKU's sales data from one year prior over the same predefined period of time, and calculate the sales forecast using an algorithm or a mathematical formula. For one embodiment of the invention, the sales forecast may be equal to approximately

$$\frac{m + 1}{m} \times n ,$$

wherein n is sales data that has been recently collected over a period of time, wherein m is sales data from one year prior over the same period of time, wherein m+1 is sales data from last year for the same period of time directly following m, wherein n, m, and m+1 are all less than six months.

Similarly, an inventory forecast may be equal to approximately

$$\frac{s + 1}{s} \times t ,$$

wherein t is inventory data that has been recently collected over a period of time, wherein s is inventory data from one year prior over the same period of time, wherein s+1 is inventory data from last year for the same period of time directly following s, wherein t, s, and s+1 are all less than six months.

Once data warehouse 110 completes the processing of the user request, the processed data is then transmitted to mobile device 150. The transmission may be made via a wireless signal. In operation 340, the processed data is received by mobile device 150. In operation 350, the processed data may be displayed on mobile device 150.

In the forgoing specification, the invention has been described with reference to specific exemplary embodiments thereof. It will, however, be evident that various modification and changes may be made thereto without departure from the broader spirit and scope of the invention as set forth in the appended claims. The specification and drawings are, accordingly, to be regarded in an illustrative rather than restrictive sense.

What is claimed is:

1. A method, comprising:
displaying a plurality of icons on a mobile device, wherein at least one of the plurality of icons provides retail store information if selected;
receiving input from a user to display retail store information;
displaying sales history of a retail store on the device;
displaying sales forecast of the retail store on the device.

2. The method of claim 1, wherein the sales history is sorted by aisle.

3. The method of claim 1, wherein the sales history is sorted by bay.

4. The method of claim 1, wherein the sales history is sorted by product.

5. The method of claim 1, wherein the sales forecast is calculated by the formula:
$$\frac{m + 1}{m} \times n ,$$
wherein n is sales data that has been recently collected over a period of time, wherein m is sales data from one year prior over the same period of time, wherein m+1 is sales data from last year for the same period of time directly following m, wherein n, m, and, m+1 are each less than six months.

6. The method of claim 5, wherein the sales data is of products sold by store-keeping unit.

7. The method of claim 5, wherein the sales data is of products sold by aisle.

8. The method of claim 5, wherein the sales data is of products sold by bay.

9. The method of claim 1, further comprising:
transmitting a request for sales history and sales forecast to a data warehouse.

10. The method of claim 1, further comprising:
receiving sales history and sales forecast of a retail store via a wireless signal.

11. A system comprising:
a data warehouse to store retail store data;
a data access object coupled to the data warehouse to access data stored in the data warehouse;
a data transmission server coupled to the data access object to transmit the data to a wireless network;
a mobile device coupled to the data transmission server to display the data to a user, wherein the data comprises sales history and sales forecast.

12. The system of claim 11, wherein the retail store data stored in the data warehouse is in American Standard Code for Information Interchange (ASCII) format.

13. The system of claim 12, further comprising:
a web service coupled to the data transmission server to format data for communication between the data warehouse and the data transmission server.

14. The system of claim 12, wherein the data is compiled from a single store location.

15. The system of claim 12, wherein the data is compiled from a plurality of store locations.

16. The system of claim 12, wherein the data displayed to the mobile device is sales data.

17. The system of claim 16, wherein the data displayed to the mobile device is sorted by department.

18. The system of claim 17, wherein the data displayed to the mobile device is a listing of departments from top to bottom based on generated revenue.

19. The system of claim 11, wherein the data displayed to the mobile device is inventory data.

20. The system of claim 19, wherein the data comprises product inventory sorted by store.

21. The system of claim 19, wherein the data comprises product inventory sorted by department.

22. The system of claim 13, wherein the web service converts data from ASCII to Extensible Markup Language (XML) format.

23. The system of claim 11, wherein the data transmission server compresses and encrypts the data prior to transmission to the wireless network.

24. A mobile device, comprising:
a means for accepting input from a user;
a means for requesting retail store information from a data warehouse;
a means for receiving retail store information from the data warehouse;
a means for displaying existing sales data;
a means for displaying forecasted sales data.

25. The mobile device of claim 24, further comprising:
a means for displaying existing inventory data;
a means for displaying forecasted inventory data.
